(19) United States
(12) Patent Application Publication
(10) Pub. No.: US 2012/0047204 A1
(43) Pub. Date: Feb. 23, 2012

(54) APPARATUS AND METHOD FOR PROVIDING A DEVICE MANAGEMENT PACKAGE AND A METHOD FOR RECEIVING THE DEVICE MANAGEMENT PACKAGE

(75) Inventors: Ji-Hye LEE, Suwon-si (KR); Wuk Kim, Anyang-si (KR)

(73) Assignee: Samsung Electronics Co., Ltd., Gyeonggi-do (KR)

(21) Appl. No.: 13/213,668

(22) Filed: Aug. 19, 2011

(30) Foreign Application Priority Data
Aug. 19, 2010 (KR) 10-2010-0080328

(51) Int. Cl. G06F 15/16

(52) U.S. Cl. 709/203

(57) ABSTRACT

A method and apparatus for receiving a Device Management (DM) package from a server cooperating with the network operator. The method includes cooperating for a DM service between a network operator and a DM package providing enterprise, determining whether a DM package is directly providable by a DM server when a device makes a DM request including its own information, transmitting a DM response including an address of an cooperation server if it is determined that a DM package is to be provided through the cooperation server, and receiving a DM package for an update operation by the device by accessing the address of the cooperation server.

### PRIORITY

This application claims priority under 35 U.S.C. §119(a) to a Korean Patent Application filed in the Korean Intellectual Property Office on Aug. 19, 2010 and assigned Serial No. 10-2010-0080328, the entire disclosure of which is hereby incorporated by reference.

### BACKGROUND OF THE INVENTION

1. Field of the Invention

The present invention relates generally to an apparatus and method for device management, and more particularly, to an apparatus and method for providing an update package to a device.

2. Description of the Related Art

A device management (DM) protocol is defined by a total of 5 messages including a package #0 to a package #4, and a DM session may be established between a DM server and DM client, i.e., a device, through the DM protocol. The DM session may be initiated by a DM server or a DM client.

FIG. 1 is a flow diagram illustrating a conventional DM session setup process.

Referring to FIG. 1, if there is a management operation to be performed in a device (e.g., a DM client 10 in the device), a DM server 20 transmits a package #0 notification message to the device to notify the DM client 10 of the existence of a DM action, in step 101. In step 103, the DM client 10 transmits a package #1 message to the DM server 20 to request a DM session setup. In step 105, the DM server 20 accepts the DM session setup and transmits a package #2 message, which carries a DM command for an intended DM operation, to the DM client 10. In step 107, in response to the package #2 message, the DM client 10 transmits a package #3 message to the DM server 20 to transmit the execution results of the DM command received from the DM server 20.

In step 109, the DM server 20 transmits a package #4 message to the DM client 10 to terminate the DM session or to transmit an additional management operation to the DM client 10. The DM client 10 performs the additional management operation included in the package #4 message, and reports the results to the DM server 20 through another package #3 message in step 111. Thereafter, the DM server 20 and the DM client 10 may provide a management operation or management commands by repeating step 109 and step 111, i.e., the package #4 message and the package #3 message transmissions. In this case, if a management operation is continuously included in the package #4 message, the DM session is maintained. If there is no additional management operation, the DM session is terminated.

As described above, a conventional DM service can be provided only through a DM server of a wireless network operator. If a large-sized firmware or software package is downloaded through a network of a wireless network operator, it usually occurs at a high cost and with a low download speed. Also, data traffic may be concentrated, thus saturating the network. If the network is saturated, a data reception error may occur in the download process.

Accordingly, a need exists for an apparatus and method for performing a DM process by downloading a firmware or software package, from another server (not from a DM server of a network operator), through a wired network or the Internet (not through a network of a wireless network operator (e.g., a 3G network)).

An additional need exists for an apparatus and method for enabling a DM server of a network operator to collect the standardized DM results, even if a device receives a DM package from the other server through specific transmission standards.

### SUMMARY OF THE INVENTION

The present invention has been designed to address at least the problems and/or disadvantages above, and to provide at least the advantages described below.

Accordingly, an aspect of the present invention is to provide an apparatus and method for efficiently providing a DM package to a device.

Another aspect of the present invention is to provide an apparatus and method for enabling a device to receive a DM package from a server cooperating with a DM server.

Another aspect of the present invention is to provide an apparatus and method for receiving a DM package by tethering to another device supporting another network.

Another aspect of the present invention is to provide an apparatus and method for enabling a DM server to receive a report on the process results of a DM package, even if a device receives the DM package from another server.

In accordance with an aspect of the present invention, a method is provided for a DM server that manages at least one device having subscribed to an operator network to provide a DM package. The method includes receiving, from a device, a DM request including device information; determining a DM package corresponding to the device, based on the device information; generating an execution file including information for receiving the DM package, if the DM package is to be provided through a cooperation server; and transmitting, to the device, a DM response including the execution file.

In accordance with another aspect of the present invention, a DM server is provided for managing at least one device, having subscribed to an operator network, and providing a DM package. The DM server includes a DM package selecting unit for receiving a DM request including device information from a device and determining a DM package corresponding to the device based on the device information; and a file generating unit for generating an execution file including information for receiving the DM package, if the DM package is determined to be provided through a cooperation server, and transmitting a DM response including the execution file in response to the DM request.

In accordance with another aspect of the present invention, a method is provided for receiving a DM package from a DM server that manages at least one device having subscribed to an operator network. The method includes transmitting, to the DM server, a DM request including device information; receiving an execution file including information for receiving a DM package from the DM server; transmitting a DM package request to a cooperation server providing the DM package, based on the information included in the execution file; receiving the DM package from the cooperation server; and installing the DM package and reporting, to the DM server, process results of the DM package.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a flow diagram illustrating a conventional DM process;

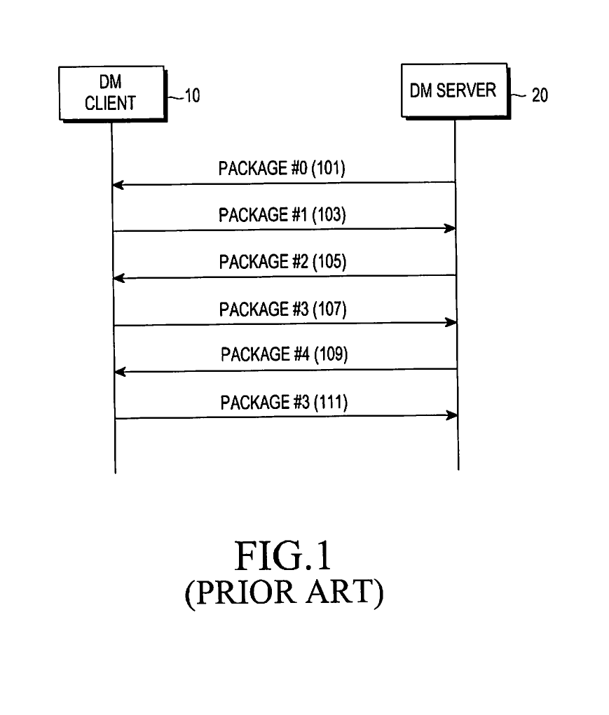

FIG. 2 is a block diagram illustrating a DM system for providing a DM package through a cooperation server according to an embodiment of the present invention;

FIG. 3 is a more detailed block diagram illustrating the DM server, the first device, and the cooperation server, as illustrated in FIG. 2, according to an embodiment of the present invention;

FIG. 4 is a flow diagram illustrating a method of providing a DM package through a cooperation server according to an embodiment of the present invention; and

FIG. 5 is a flow diagram illustrating a method of providing a DM package by tethering to another device according to an embodiment of the present invention.

### DETAILED DESCRIPTION OF EMBODIMENTS OF THE INVENTION

Various embodiments of the present invention will be described in detail below with reference to the accompanying drawings. However, the present invention may be embodied in different forms and should not be construed as limited to the embodiments set forth herein; rather, these embodiments are provided so that this disclosure will be thorough and complete, and will fully convey the scope of the present invention to those skilled in the art. In the following description, detailed descriptions of well-known functions or configurations will be omitted to avoid obscuring the subject matter of the present invention in unnecessary detail.

For ease of description, the embodiments of the present invention are described using terms and entities defined in the Device Management (DM) protocol of the Open Mobile Alliance (OMA), which is an organization for standardization of applications of mobile terminals. However, it should be noted that the scope of the present invention is not limited by such terms, and the present invention may also be applicable to systems with similar technical backgrounds.

In accordance with an embodiment of the present invention, a method is provided for receiving a DM package from a server cooperating with a network operator, i.e., not from a DM server of the network operator. The method includes cooperating for a DM service between a network operator and an enterprise providing a DM package, determining whether a DM package is directly providable by a DM server, when a device makes a DM request including its own information, transmitting a DM response including an address of an cooperation server, if the DM package is determined to be provided through the cooperation server, and receiving a DM package for an update operation by the device by accessing the address of the cooperation server.

The method also includes providing the address of the cooperation server by tethering to another device, if the device is capable of tethering to the other device, and a process of forwarding a DM package to the device when the other device receives the DM package by accessing the address of the cooperation server.

As described above, according to the present invention, the network operator provides only an execution file for DM guidance, and the device performs a DM process and transmits only the process results to the network operator. Accordingly, the network operator can manage a plurality of devices simultaneously, and the device can download an update package from another external network with better network conditions and can transmit the DM process results asynchronously, efficiently providing a DM service.

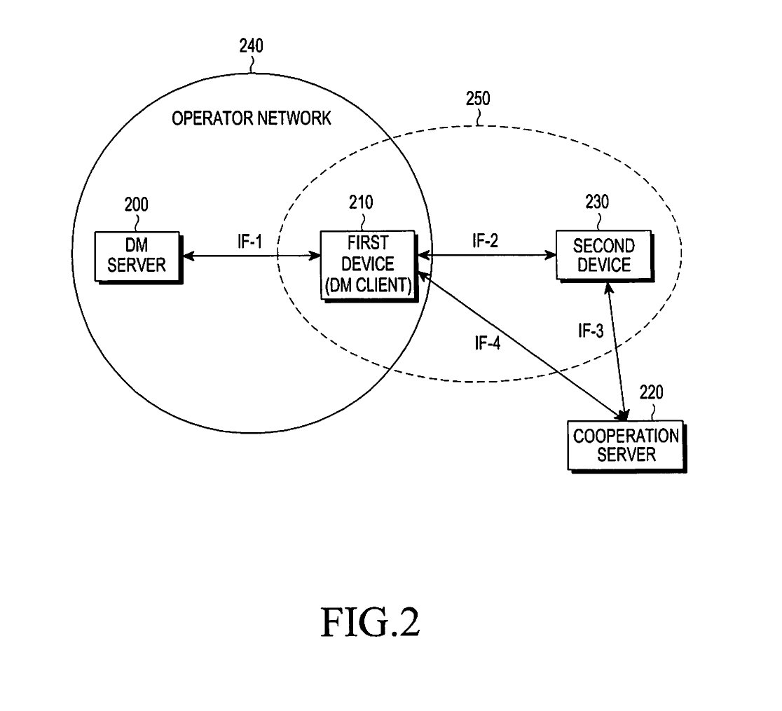

FIG. 2 is a block diagram illustrating a DM system for providing a DM package through a negotiation server according to an embodiment of the present invention.

Referring to FIG. 2, the DM system includes a DM server 200, a first device 210 with a DM client, a cooperation server 220, and a second device 230 for connection between the first device 210 and the cooperation server 220.

The DM server 200 is included in an operator network 240. The DM server 200 manages and stores information about network subscriber devices, and performs DM operations such as firmware update, software update, remote diagnosis and monitoring, and initial setting of each subscriber device.

The DM server 200 directly provides a DM package for update operations (e.g., firmware update and software update) to a device having subscribed to a DM service through a DM session. Before providing the DM package, the DM server 200 determines the restrictions on providing the DM package, if the DM package affects the download price and speed, or has to be received from an update firmware/software production enterprise due to its large size.

When the DM package cannot be directly provided to the device due to the above restrictions, according to an embodiment the present invention, the DM server 200 participates only in a DM process and providing an execution file including environment configuration, and delegates a DM package providing function to the cooperation server 220 cooperating with the network operator. If the network operator delegates a DM package transmitting function to a cooperation enterprise, the cooperation enterprise provides a DM package to a device having requested a DM service. Herein, the network operator may cooperate with one or more cooperation enterprises for a DM service.

To delegate a DM package transmitting function to the cooperation server 220, the DM server 200 generates and provides an execution file including information, which is used by the first device 210 to receive a DM package from the cooperation server 220, and report conditions for the process results of the DM package. Accordingly, the DM server 200 can provide an efficient DM service by the minimum interaction.

The first device 210 subscribes to the operator network 240. For example, the first device 210 may be a subscriber device such as a mobile phone, a notebook computer, an MP3 player, or a TV that utilizes device management such as firmware update, software update, and environment configuration. The first device 210 may be a device having subscribed to a DM service in the operator network 240, and may include a DM client that processes DM messages and commands and manages access to a DM tree.

The first device 210 establishes a DM session with the DM server 200, and receives an execution file from the DM server 200 at the early stage of the DM session. The execution file includes information for updating. Based on the information, the first device 210 receives a DM package from the cooperation server 220 and installs the DM package. Thereafter, the first device 210 transmits the process results of the DM package to the DM server 200 according to the report conditions included in the execution file. Herein, the first device 210 may be directly connected to the cooperation server 220 to receive the DM package from the cooperation server 220, or may be tethered (250) to the second device 230 to receive the DM package from the cooperation server 220 through the second device 230.

The cooperation server 220 is included in an enterprise cooperating with the network operator, and is located on a network different from that of the network operator. The cooperation server 220 provides a DM package for updating software or firmware necessary for a DM operation. For example, the cooperation server 220 may be a server of an Original Equipment Manufacturer (OEM) content providing enterprise such as a software (e.g., security program) developing enterprise or a device manufacturer cooperating with the network operator, or may be a content server of the network operator managing the DM server 200.

The second device 230, e.g., a notebook computer or a desktop computer, has a function of accessing an operator network and another external network (e.g., Internet). The second device 230 can directly communicate with the first device 210 through a Universal Serial Bus (USB), Bluetooth®, or data cables while accessing an external network such as a wired network or a WiFi® network.

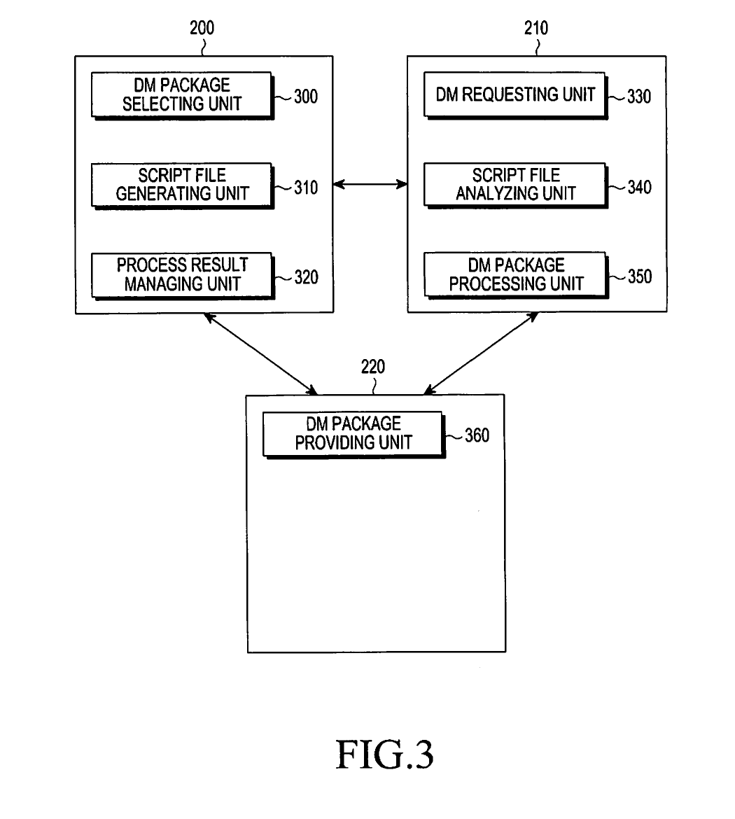

FIG. 3 is a detailed block diagram illustrating the DM server 200, the first device 210, and the cooperation server 220 in the DM system, according to an embodiment of the present invention.

Referring to FIG. 3, the DM server 200 includes a DM package selecting unit 300, a script file generating unit 310, and a process result managing unit 320. The DM server 200 cooperates with the cooperation server 220 for a DM service and then delegates a DM package providing function to the cooperation server 220. This cooperation process is performed according to a negotiation between the network operator and the cooperation enterprise, and in accordance with an embodiment of the present invention, a DM package is provided on the assumption that the network operator and the cooperation enterprise have cooperated for a DM service. Thus, a detailed description of the cooperation process is omitted for conciseness.

Because the DM server 200 manages one or more devices having subscribed to the operator network, DM packages may vary according to the software or firmware necessary for the respective devices. Accordingly, through the cooperation process, the DM server 200 may cooperate for a DM service with a plurality of cooperation enterprises, such as an enterprise providing a DM package for firmware update and an enterprise providing a DM package for software update. The DM service may include Firmware Update Management Object (FUMO) update, Software COmponent Management Object (SCOMO) update, Diagnosis/Monitoring (DiagMon), and environment configuration. Herein, it is assumed that the DM server 200 cooperates with a cooperation enterprise for a DM service including firmware update and software update.

Upon receiving a DM request from the first device 210, the DM package selecting unit 300 determines a DM package suitable for the first device 210, based on device information of the first device 210 included in the DM request. The device information of the first device 210 may include information about networks supported by the first device 210, a device IDentifier (ID), a device manufacturer, a device model name, a version of a DM client installed in the first device 210, language in use, and a type of DM package requiring firmware/software update.

In order to determine a DM package suitable for the device information of the first device 210, the DM package selecting unit 300 determines restrictions on providing the DM package, such as whether the DM package is large, and whether the DM package is to be received from an enterprise producing update firmware/software. If a DM package does not correspond to the restrictions, the DM package selecting unit 300 directly transmits the DM package to the first device 210. Herein, the DM package selecting unit 300 transmits a DM response including the DM package to the first device 210.

However, if a DM package corresponds to the restrictions, the DM package selecting unit 300 determines a cooperation enterprise that can provide the DM package. The DM package selecting unit 300 provides server information of the determined cooperation enterprise to the script file generating unit 310 in order to generate a script file.

Based on the device information, the script file generating unit 310 generates an execution file including environment configuration and a DM process and provides the execution file to the first device 210. The execution file has the format of a script file. The script file includes information that is used by the first device 210 to receive a DM package from the cooperation server 220. Table 1 below shows an example of a structure of the script file.

TABLE 1
Alert Message for Tethering Instruction
OEM Content Server Address
Transmission Network Type and Priority (e.g., USB, Bluetooth, and WiFi)
Firmware or Software Version
Device Manufacturer and Model Name
Package Download Schedule Selection (e.g., at a predetermined time,
after a predetermined time, randomly, and immediately)
Package Installation Option (e.g., at a predetermined time, and
immediately)
Connection Retry Algorithm
DM Result Report Schedule
Package Error Correction

In Table 1, a field of Alert Message for Tethering Instruction represents a command for ordering the first device 210 to tether to the second device 230. The script file generating unit 310 can set a tethering execution command because it can know that it is connected to another device through USB or Bluetooth on the basis of information about networks supported by the first device 210. If there is no information about USB and Bluetooth among information about networks supported by the first device 210, a tethering execution command is not set in the field of Alert Message for Tethering Instruction.

A field of OEM Content Server Address represents an address of the cooperation server 220 so that the first device 210 can be directly connected to the cooperation server 220. A field of Transmission Network Type and Priority is to set networks (e.g., 3G, WiFi, Bluetooth, and USB) for transmission of DM packages and indicate a network connection scheme in the first device 210. Based on the device information from the first device 210, the DM server 200 can know the capability of the first device 210, that is, information about networks supportable by the first device 210. Accordingly, the DM server 200 determines the priority among the supportable networks, in consideration of the information about networks supportable by the first device 210 and/or the restrictions on providing a DM package. The DM server 200 may set any one of the supportable networks.

As described above, the transmission network type and priority may be determined based on the supportable network information of the first device 210. However, if the DM server 200 determines the transmission network type and priority in consideration of only the restrictions on providing a DM package, without reference to the supportable network information of the first device 210, the first device 210 may determine a currently supportable network among the transmission network types presented by the script file analyzed.

A field of Firmware or Software Version represents a version of a DM package to be received by the first device 210. A field of Device Manufacturer and Model Name is used by the cooperation server 220 to provide a DM package suitable for the first device 210. A field of Package Download Schedule Selection is used by the DM server 220 to allow the first device 210 to set a download time of a DM package, e.g., “at a predetermined time”, “after a predetermined time”, “randomly”, and “immediately”. A field of Package Installation Option is used by the first device 210 to set an installation time of a received DM package, e.g., “at a predetermined time” and “immediately”. A field of Connection Retry Algorithm may represent connection retry information such as the number of times of retrying connection if the first device 210 fails to connect with the cooperation server 220.

A field of DM Result Report Schedule is used by the DM server 200 to set a time of receiving the process results of a DM package installed in the first device 210, e.g., “at a predetermined time”, “after a predetermined time”, and “immediately”. A field of Package Error Correction may be used to prevent a data reception error from occurring in a DM package download process.

The process result managing unit 320 receives and manages the process results of a DM package, including an installation completion time and a version of the DM package installed in the first device 210. Accordingly, the DM server 200 can collect the standardized DM results, even if the first device 210 receives a DM package through the unique transmission standard of the cooperation server 220.

The first device 210 includes a DM requesting unit 330, a script file analyzing (parsing) unit 340, and a DM package processing unit 350.

The DM requesting unit 330 generates a DM request message and transmits the DM request message to the DM server 200. The DM request message includes information about the first device 210 requesting device management. In accordance with an embodiment of the present invention, the DM requesting unit 330 may transmit the DM request message to the DM server 200 after receiving a notification message for notifying the initiation of a DM service, from the DM server 200. In accordance with another embodiment of the present invention, the DM requesting unit 330 may transmit the DM request message to the DM server 200 without receiving such a notification message.

The script file analyzing unit 340 analyzes a script file received with a DM session established with the DM server 200, thereby detecting the indications for receiving a DM package.

The DM package processing unit 350 may directly receive a DM package from the DM server 200. Alternatively, according to the analysis results of the script file, the DM package processing unit 350 may receive a DM package from the cooperation server 220 or the second device 230 connectable to the cooperation server 220.

Upon completion of the download of the DM package, the DM package processing unit 350 installs the DM package based on the package installation option field of the script file. Thereafter, the DM package processing unit 350 transmits the process results of the DM package to the DM server 200 based on the DM result report schedule field of the script file.

The cooperation server 220 includes a DM package providing unit 360. When receiving a DM package request through a connection with the first device 210 or the second device 230, the DM package providing unit 360 provides a DM package to the first device 210 or the second device 230, based on the version of a DM package requiring update included in the DM package request.

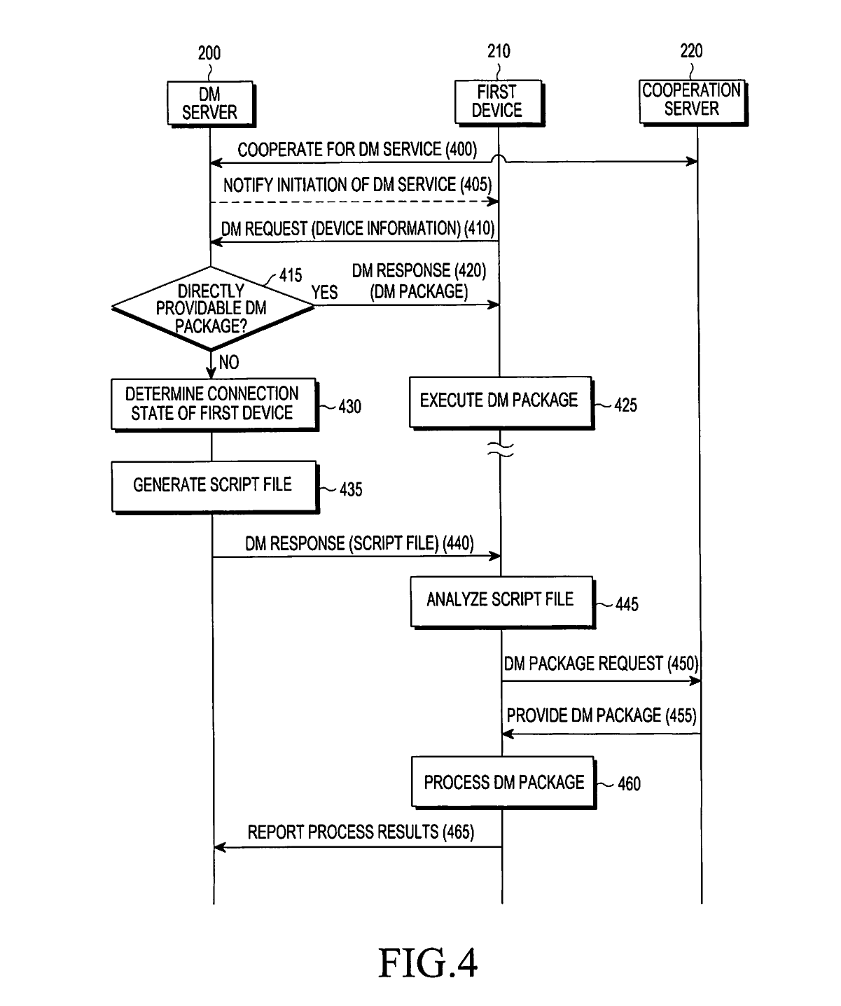

FIG. 4 is a flow diagram illustrating a method of providing a DM package through a cooperation server according to an embodiment of the present invention.

Referring to FIG. 4, in step 400, the DM server 200 cooperates for a DM service with the cooperation server 220 providing a DM package. This cooperation process is performed according to a negotiation between the network operator and the cooperation enterprise. Although FIG. 4 illustrates a cooperation process with only one cooperation server 220, it will be understood that the DM server 200 may cooperate with a plurality of cooperation enterprises according to packages for updating.

In step 405, the DM server 200 sends a notification of the initiation of a DM service to the first device 210. In step 410, the first device 210 transmits a DM request including device information to the DM server 200, in response to the notification. Herein, the DM request may be transmitted according to the interaction with a user or a DM client, even without the notification of the DM service initiation. In this manner, the DM request may be transmitted to initiate a DM session.

Upon receiving the DM request, the DM server 200 selects a DM package corresponding to the first device 210, based on the device information. For example, the DM server 200 selects the DM package in consideration of a type of a DM service requiring update and a device model name included in the device information. When a DM package to be provided to the first device 210 is selected, the DM server 200 determines the restrictions on providing the selected DM package. For example, according to restrictions, such as whether the DM package is very large and/or whether the DM package is to be received from a cooperation enterprise, the DM server 200 determines whether to directly provide the selected DM package to the first device 210.

In step 415, the DM server 200 determines whether the selected DM package is directly providable. If the selected DM package is directly providable, the DM server 200 transmits a DM response including the selected DM package to the first device 210, in step 420. In step 425, the first device 210 installs and executes the DM package, included in the DM response, according to a general DM process.

However, if the selected DM package is not directly provided in step 415, the DM server 200 determines the connection state of the first device 210 in step 430. That is, the DM server 200 determines whether the first device 210 is connected to an external network through other device.

Specifically, the DM server 200 determines whether there is Bluetooth/USB network information among the supportable network information of the first device 210. Herein, the Bluetooth/USB network information indicates that the first device 210 is connected to another device through a Bluetooth/USB scheme. Thus, if there is no Bluetooth/USB network information, the DM server 200 generates a script file in step 435 so that the first device 210 can be directly connected to a server of a cooperation enterprise providing a DM package. The script file includes information for performing a DM process through the direct connection of the first device 210 with the server of the cooperation enterprise, and an operation of generating the script file is the same as described above.

In step 440, the DM server 200 transmits a DM response including the generated script file to the first device 210. The first device 210 executes the script file included in the DM response and analyzes the script file in step 445. Based on the analysis results, the first device 210 connects with the cooperation server 220 according to the instruction of each field of the script file. To this end, the first device 210 refers to a transmission network type/priority field of the script file and an OEM content server address field of the script file representing the address of the cooperation server 220. Herein, the network designated by the DM server 200 is set in the transmission network type/priority field of the script file.

Thus, with reference to the transmission network type/priority field of the script file, the first device 210 selects a transmission network for downloading a DM package. The first device 210 can download the DM package through a transmission network with better conditions.

In step 450, the first device 210 transmits a DM package request to the cooperation server 220 through the selected transmission network. The DM package request includes package information requiring update in the first device 210.

In step 455, the cooperation server 220 provides a DM package to the first device 210 in response to the DM package request. In step 460, the first device 210 processes the DM package. Specifically, the first device 210 installs the DM package according to the package installation option of the script file.

In step 465, the first device 210 reports the process results of the DM package to the DM server 200 according to the DM result report schedule.

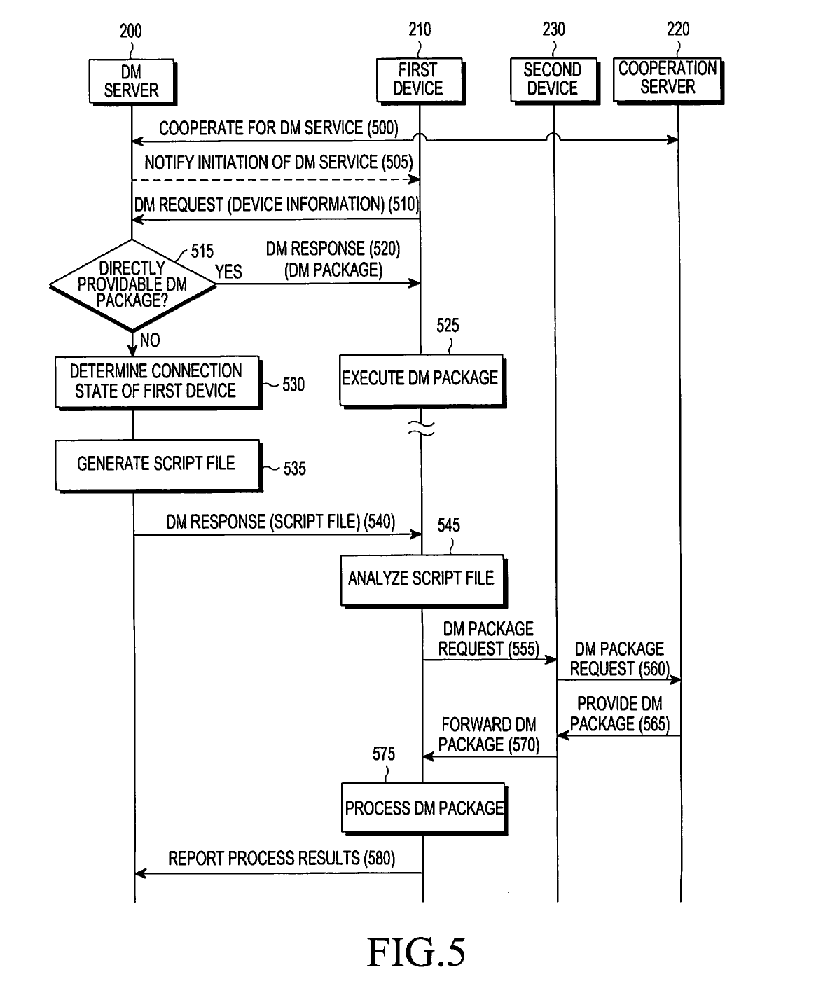

FIG. 5 is a flow diagram illustrating a method of providing a DM package by tethering to another device according to an embodiment of the present invention. In FIG. 5, steps 500 to 525 are identical to steps 400 to 425 of FIG. 4 already described above. Accordingly, a detailed description of steps 500 to 525 will be omitted for conciseness.

Referring to FIG. 5, the DM server 200 determines the connection state of the first device 210 in step 530. Specifically, the DM server 200 determines whether there is Bluetooth/USB network information among the supportable network information of the first device 210. Herein, if there is Bluetooth/USB network information, it indicates that the first device 210 is connected to other device through a Bluetooth/USB scheme.

The DM server 200 may order the first device 210 to receive a DM package from a server of an enterprise cooperating with the network operator, not through the operator network, but through the connection with other device supporting another external network.

Accordingly, if there is no Bluetooth/USB network information, the DM server 200 generates a script file in step 535, such that the first device 210 can be connected by tethering to the second device 230. The script file includes information used by the first device 210 to connect with the second device 230 connectable to a server of a cooperation enterprise providing a DM package and information used by the second device 230 to download the DM package from the server of the cooperation enterprise.

In step 540, the DM server 200 transmits a DM response including the generated script file to the first device 210. In step 545, the first device 210 analyzes the script file included in the DM response. Based on the analysis results, the first device 210 selects a network according to the instruction of each field of the script file and connects with the second device 230 supporting the selected network. Thereafter, in step 555, the first device 210 transmits a DM package request to the second device 230. The DM package request includes an address of the cooperation server 220 obtained from the script file and package information requiring update. Messages in steps 555 to 570 may be transmitted according to the unique transmission standard of the cooperation server 220.

In step 560, the second device 230 accesses the cooperation server 220 with reference to the address of the cooperation server 220 and transmits a DM package request, including package information requiring update, to the cooperation server 220. In step 565, the cooperation server 220 provides a DM package corresponding to the first device 210, to the second device 230. In step 570, the second device 230 forwards the DM package to the first device 210.

Steps 575 and 580 performed by the first device 210 having received the DM package are identical to steps 460 and 465 of FIG. 4, as described above. The first device 210 can perform a DM operation by downloading a DM package for update, even when receiving only the script file from the DM server 200. Accordingly, the DM server 200 can manage a plurality of devices simultaneously, thus making it possible to provide an efficient DM service.

According to embodiments of the present invention, the network operator provides the device with information for receiving an update package from the cooperation server, without the need to directly transmit an update package for device management through the DM server, thereby making it possible to increase the network efficiency.

Thus, the DM server according to an embodiment of the present invention can manage a plurality of devices simultaneously. Also, the device according to the present invention can download an update package from a cooperation server of other external network (not a wireless operator network) and can transmit the process results of the update package asynchronously. Thus, it is possible to prevent a reception rate decrease or a signal interruption that may occur when the network is saturated due to the concentration of data traffic in the operator network.

Also, according to an embodiment of the present invention, the device can select a fee-saving network or a network providing a high data rate, because it can tether to another device supporting another network, when it downloads an update package from the cooperation server.

Also, according to an embodiment of the present invention, the DM server can collect the standardized DM package process results, even if the device receives a DM package through the unique transmission standard of the cooperation server.

While the present invention has been shown and described with reference to certain embodiments thereof, it will be understood by those skilled in the art that various changes in form and details may be made therein without departing from the spirit and scope of the present invention as defined by the appended claims. Therefore, the scope of the present invention is defined not by the detailed description above, but by the appended claims, and any equivalents thereof

What is claimed is:

1. A method for providing a Device Management (DM) package by a DM server that manages at least one device subscribing to an operator network, the method comprising the steps of:
receiving, from a device, a DM request including device information;
determining a DM package corresponding to the device, based on the device information;
generating an execution file including information for receiving the DM package, if the DM package is to be provided through a cooperation server; and
transmitting, to the device, a DM response including the execution file.

2. The method of claim 1, further comprising cooperating with the cooperation server for a DM service.

3. The method of claim 1, wherein the device information includes at least one of information about networks supported by the device, a device ID, a device manufacturer, a device model name, a version of a DM client installed in the device, and language in use, and a type of DM package requiring update.

4. The method of claim 3, wherein generating the execution file comprises:
determining whether the device is capable of tethering to another device, based on the information about networks supported by the device; and
if the device is capable of tethering to other device, generating the execution file including information that is used by the device to receive the DM package from the cooperation server through the another device.

5. The method of claim 1, wherein the execution file includes at least one of an alert message for a tethering instruction with respect to another device, an address of the cooperation server, a transmission network type and priority, a version of the DM package, a device manufacturer and model name, a download schedule of the DM package, an installation option of the DM package, a connection retry algorithm, a DM result report schedule, and a package error correction.

6. The method of claim 5, wherein the transmission network type and priority is determined based on the information about the networks supported by the device, among the device information.

7. The method of claim 5, further comprising receiving a result report about installation of the DM package from the device according to the DM result report schedule.

8. The method of claim 7, wherein the result report includes at least one of an installation completion time and a version of the DM package installed in the device.

9. The method of claim 1, further comprising transmitting the DM response including the DM package in response to the DM request, if the DM package is determined to be directly providable.

10. A Device Management (DM) server for managing at least one device, which subscribes to an operator network, and providing a DM package, comprising:
a DM package selecting unit for receiving a DM request including device information from a device and determining a DM package corresponding to the device based on the device information; and
a file generating unit for generating an execution file including information for receiving the DM package, if the DM package is determined to be provided through a cooperation server, and transmitting a DM response including the execution file in response to the DM request.

11. The DM server of claim 10, wherein the cooperation server is included in a cooperation enterprise cooperating with the DM server of a network operator for a DM service.

12. The DM server of claim 10, wherein the device information comprises:
at least one of information about networks supported by the device, a device ID, a device manufacturer, a device model name, a version of a DM client installed in the device, and language in use; and
a type of DM package requiring update.

13. The DM server of claim 12, wherein the file generating unit determines whether the device is capable of tethering to another device, based on the information about networks supported by the device, and if the device is capable of tethering to the another device, generates the execution file including information that is used by the device to receive the DM package from the cooperation server through the another device.

14. The DM server of claim 10, wherein the execution file comprises at least one of:
an alert message for a tethering instruction with respect to another device;
an address of the cooperation server;
a transmission network type and priority;
a version of the DM package;
a device manufacturer and model name;
a download schedule of the DM package;
an installation option of the DM package;
a connection retry algorithm;
a DM result report schedule; and
a package error correction.

15. The DM server of claim 14, wherein the transmission network type and priority is determined based on the information about the networks supported by the device, among the device information.

16. The DM server of claim 14, further comprising a process result managing unit for receiving a result report, including at least one of an installation completion time and a version of the DM package installed in the device, from the device according to the DM result report schedule.

17. A method for receiving a Device Management (DM) package from a DM server that manages at least one device that subscribes to an operator network, the method comprising the steps of:
transmitting, to the DM server, a DM request including device information;
receiving an execution file including information for receiving a DM package from the DM server;
transmitting a DM package request to a cooperation server providing the DM package, based on the information included in the execution file;
receiving the DM package from the cooperation server; and
installing the DM package and reporting, to the DM server, process results of the DM package.

18. The method of claim 17, wherein the device information includes at least one of information about networks supported by the device, a device ID, a device manufacturer, a device model name, a version of a DM client installed in the device, and language in use, and a type of DM package requiring update.

19. The method of claim 17, wherein the execution file includes at least one of an alert message for a tethering instruction with respect to another device, an address of the cooperation server, a transmission network type and priority, a version of the DM package, a device manufacturer and model name, a download schedule of the DM package, an installation option of the DM package, a connection retry algorithm, a DM result report schedule, and a package error correction.

20. The method of claim 19, wherein installing the DM package and reporting the process results of the DM package to the DM server comprises:
installing the DM package according to the installation option of the DM package; and
transmitting a result report, including at least one of an installation completion time and a version of the DM package installed in the device, to the DM server according to the DM result report schedule.
